(19) United States
(12) Patent Application Publication
(10) Pub. No.: US 2008/0104065 A1
(43) Pub. Date: May 1, 2008

(54) AUTOMATIC GENERATOR AND UPDATER OF FAQS

(75) Inventors: REENA AGARWAL, Bellevue, WA (US); Edward David Harris, Bellevue, WA (US); Nils Henry Pohlmann, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/553,136

(22) Filed: Oct. 26, 2006

(51) Int. Cl. G06F 17/30

(52) U.S. Cl. 707/6

(57) ABSTRACT

Automatically generating and updating of frequently asked question (FAQ) lists are described herein. User inputs requesting information are matched to stored question and answer pairs, and values associated with the stored question and answer pairs are manipulated. An FAQ list may be generated and updated by selecting relevant question and answer pairs by comparing parameters supplied by an authoritative user (e.g., a webmaster) with values associated with the stored question and answer pairs. Selected question and answer pairs are added to the FAQ list, which may be displayed on a web site. Additionally, the FAQ list may be updated with new question and answer pairs based on parameters from the authoritative user or varying values in known question and answer pairs.

### BACKGROUND

The Internet is extremely popular in today's society. Information about virtually every type of product or service can typically be found within some web site. Many web sites contain a frequently asked question (FAQ) list to quickly answer common concerns. Typically, an FAQ list consists of a series of questions that are immediately followed by respective answers—all of which are presented on a web page. This allows a visitor to the web page to quickly find relevant information or answers to questions other visitors are asking.

One drawback to traditional FAQ lists is that they must be created manually. In other words, a webmaster, or other user with authority to modify the web site, must manually enter frequently asked questions and answers into a web page. Over time, the questions and answers may become stale or less important. Changing outdated materials requires manually deleting the outdated questions or answers. Thus, keeping information fresh in an FAQ list can be a tedious process. As a result, vigilant management of the FAQ list is required to maintain up-to-date questions and answers.

In addition, it is difficult to determine the most frequently asked questions and answers for display in an FAQ list. To do so requires wading through numerous questions, determining they have useful answers, and measuring the number of times questions can be matched to specific answers. As can be imagined, this editorial process can be tedious work and time consuming.

Furthermore, the answers to some questions on the FAQ list may change more rapidly than answers to other questions. For example, suppose an FAQ contains a question about the deadline for early registration for a seminar and another question about the refund policy for the seminar. The deadline may change every few months, while the refund policy may continually stay the same. In that situation, only the deadline answer would need to be updated. Constantly monitoring the relevance of every question on an FAQ may require numerous human and technical resources.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Automatically generating and updating an FAQ list of question and answer pairs is described herein. A user submits a user input, which may be a question or keyword query for information. Once received, it is determined whether a stored question and answer pair corresponds to the user input. Various values associated with the question and answer pairs are then manipulated to indicate that the question and answer pair was accessed. Question and answer pairs are selected for inclusion in the FAQ list based on the various values in conjunction with parameters supplied by an authoritative user (e.g., a webmaster). Once relevant question and answer pairs are selected, the FAQ list can then be generated. Additionally, the question and answer pairs on the FAQ list may be updated or modified based on additional parameters from the authoritative user or changes in the various values associated with the question and answer pairs.

### BRIEF DESCRIPTION OF THE SEVERAL VIEWS OF THE DRAWINGS

The present invention is described in detail below with reference to the attached drawing figures, wherein:

FIG. 1 is a block diagram of a computing-system environment for use in implementing an embodiment of the present invention;

FIG. 2 is a block diagram of a networking environment for use in implementing an embodiment of the present invention;

FIG. 3 is a flowchart illustrating a process for manipulating values associated with question and answer pairs based on a user's input, according to various embodiments of the present invention; and

FIG. 4 is a flowchart illustrating a process for automatically generating and updating an FAQ list, according to various embodiments of the present invention.

### DETAILED DESCRIPTION

The subject matter described herein is presented with specificity to meet statutory requirements. The description herein, however, is not intended to limit the scope of this patent. Rather, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

Embodiments described herein generally relate to automatically generating and updating a list of question and answer pairs in an FAQ list. It will be understood to those skilled in the art that an FAQ list comprises a list of questions and respective answers. It should also be understood that a question generally refers to an information request about any topic, while an answer generally indicates a reply to the information request. Furthermore, multiple answers may be associated with a single question. In some embodiments of the present invention, the most accurate answer is selected for display on the FAQ list. Accuracy of an answer may be measured using a plurality of parameters, such as user rankings or matching keywords.

Some embodiments discussed herein are directed to one or more computer-readable media for automatically generating the FAQ list. A user input may initially be received. The user input may be used to determine or identify question and answer pairs from a plurality of known question and answer pairs. Once the question and answer pairs are determined or identified, various values related to the question and answer pairs can then be manipulated. Such values may include a frequency rank indicative of the number of times the determined or identified question and answer pairs have been accessed. Based on the values, question and answer pairs can be selected for inclusion in the FAQ list.

Other embodiments discussed herein are directed to a computer-implemented method for automatically generating an FAQ list on a web site. In an embodiment, one or more parameters are received from an authoritative user (e.g., a webmaster, developer, or other person with web-modification rights) for selecting one or more question and answer pairs. A plurality of question and answer pairs may be accessed to determine which to include on the FAQ list. In an embodiment, question and answer pairs are selected for inclusion on the FAQ list based on the parameters and values associated with the question and answer pairs.

Other embodiments discussed herein relate to a server for automatically generating one or more FAQ lists on a web site. In an embodiment, a matching component is configured to determine question and answer pairs corresponding to user inputs requesting information. An updating component may be configured to modify values associated with stored question and answer pairs. And a selecting component executing on the server may be configured to select question and answer pairs for inclusion on the FAQ list based on the values.

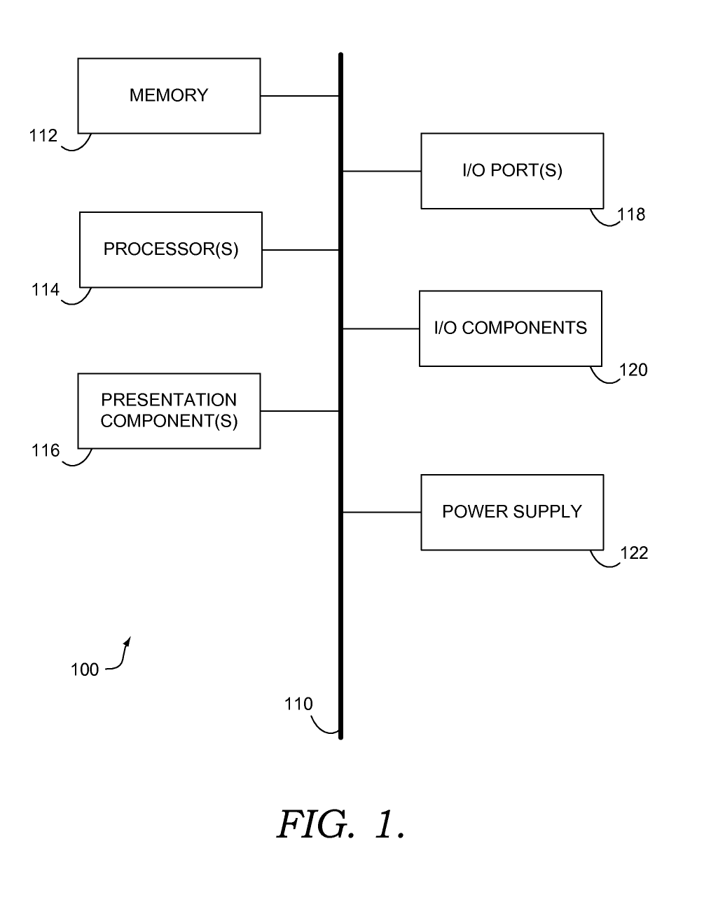

Having briefly described a general overview of the embodiments described herein, an exemplary operating environment is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, digital phone, handheld device, personal digital assistant (“PDA”), or other device capable of executing computer instructions.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

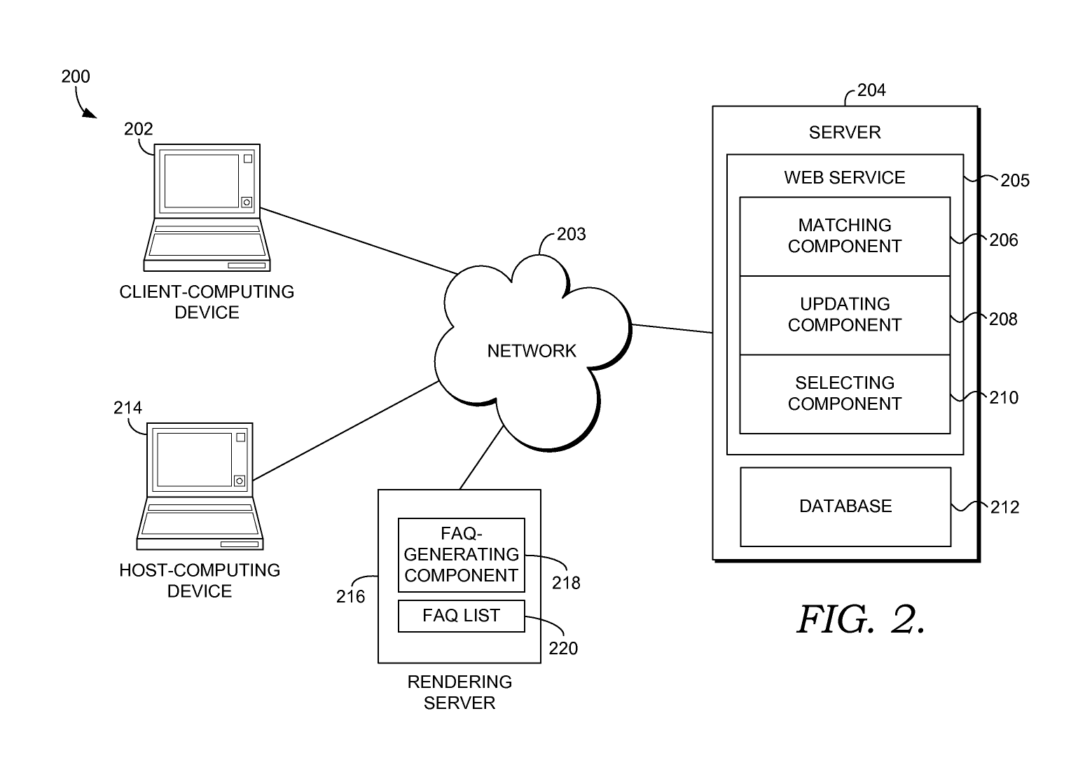

Referring to FIG. 2, a block diagram is illustrated showing an exemplary networking environment 200 for use in implementing an embodiment of the present invention. System 200 comprises a client-computing device 202, a server 204 executing a web service 205, a host-computing device 214, and a rendering server 216, all of which are configured to communicate via network 203.

Both the client-computing device 202 and the host-computing device 214 may be any type of computing device, such as computing device 100 described above with reference to FIG. 1. By way of example only and not limitation, the client-computing device 202 and the host-computing device 214 may be one or more personal computers, servers, desktop computers, laptop computers, handheld devices, cellular phones, digital phones, PDAs, or the like. It should be noted that the embodiments are not limited to implementation on such computing devices, but may be implemented on any of a variety of different types of computing devices.

Network 203 may include any computer network or combination thereof. Examples of computer networks configurable to operate as network 203 include, without limitation, a wireless network, landline, cable line, fiber-optic line, LAN, WAN, or the like. Network 203 is not limited, however, to connections coupling separate computer units. Rather, network 203 may also comprise subsystems that transfer data between servers or computing devices. For example, network 203 may also include a point-to-point connection, Ethernet, backplane bus, electrical bus, neural network, or other internal system.

In an embodiment where network 203 comprises a LAN networking environment, components are connected to the LAN through a network interface or adapter. In an embodiment where network 203 comprises a WAN networking environment, components use a modem, or other means for establishing communications over the WAN, to communicate. In embodiments where network 203 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The server 204 and the rendering server 216 may each include any type of application server, database server, or file server configurable to perform the methods described herein. In addition, the server 204 and the rendering server 216 may each be a dedicated or shared server. One example, without limitation, of a server that is configurable to operate as the server 204 or the rendering server 216 is a structured query language (“SQL”) server executing server software such as SQL Server 2005, which was developed by the Microsoft® Corporation headquartered in Redmond, Wash.

Components of the server 204 and the rendering server 216 (not shown for clarity) may include, without limitation, a processing unit, internal system memory, and a suitable system bus for coupling various system components, including the database 212 for storing information, such as a list of a plurality of question and answer pairs. The server 204 and the rendering server 216 will typically include, or have access to, a variety of the aforementioned computer-readable media. Specifically, the server 204 may directly be coupled to database 212, which can be any of the computer-readable media described herein. By way of example only, and not limitation, computer-readable media may include computer-storage media and communication media. In general, communication media enables the server 204 and the rendering server 216 to exchange data via network 203. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

In one embodiment, a list of all stored question and answer pairs is stored on the database 212. Additionally, a plurality of values associated with each of the stored question and answer pairs within the list may also be stored on the database 212. For example, each question and answer pair may have keywords, hypertext markup language (HTML) tags, meta tags, dates, times, geographic locations, user rankings, or other alphanumeric values associated therewith. More specifically, a user ranking may include any ranking, based on input from one or more web users, of the relationship of the answer to the question in a given question and answer pair. For instance, a user may wish to rank a particular answer as “poor,” “average,” or “accurate” or a question and answer pair as informative. In an embodiment, user rankings are submitted by web users to rank or score an answer or question and answer pair. User rankings, once submitted, are used to manipulate a value related to the answer or question and answer pair. One skilled in the art will appreciate that various methods exist for submitting user rankings and manipulating corresponding values. Furthermore, the aggregate value of multiple user rankings may also be stored in the database 212 along with an answer or question and answer pair. For example, fifty users may submit a user ranking of four, while fifty other users may submit a user ranking of two. The aggregate user ranking would then be three, and a value delineating aggregate user rankings could be updated accordingly.

It will be understood by those of ordinary skill in the art that system 200 is merely exemplary. While the server 204 and the rendering server 216 are illustrated as a single box, one skilled in the art will appreciate that both servers are scalable. For example, the server 204 may, in actuality, include a plurality of servers in communication. Furthermore, the database 212, while illustrated within the server 204, may alternatively be located externally from the server 204. In such a configuration, the server 204 and the rendering server 216 may be configured to communicate with the database 212 via network 203. The single unit depictions in FIG. 2 are illustrated for clarity, and should not be construed to limit the scope of embodiments described herein.

As previously mentioned, the database 212 stores known question and answer pairs along with associated values. These known question and answer pairs may be stored by various other applications or services (not pictured for clarity) that monitor questions being asked online. A backend server (not shown for clarity) may also be used to determine best answers to questions. To do so, the backend server, in an embodiment, compares the various values associated with each question and answer. User rankings, aggregate user rankings, meta tags, dates, geographic locations, times, or other values provide insightful information into relevance of a particular answer and may be used to determine the best answers to particular questions. For example, the answer with the highest aggregate user ranking may be considered the best answer for given question. Consequently, the answer could be stored with the question in the database 212 as a question and answer pair. Other methods for designating better answers over others may also be used and are generally well known to those skilled in the art.

In operation, a user requests information on the client-computing device 202 by submitting a user input. The user input may include any well-known method for requesting information about a topic online. In some embodiments, the user enters a question or keyword into a text field and a query is submitted to a matching component 206 (discussed below). In an alternative embodiment, a submitted question or keyword query initiates an application presenting alternative questions that are closely related to the question or keyword. Alternative questions can be located by searching an index of known question and answer pairs and returning those questions that are similar but do not completely match. In such an embodiment, the user may simply select one of the alternative questions, and that selection would constitute the user input. In still another embodiment, the user selects a question presented on a web page. Other methods of submitting a user input are generally well known to those of skill in the art.

The server 204 comprises a web service 205 that is called when the user input is submitted. The web service 205 may be any software system or application accessible over an open protocol. Examples of open protocols include, without limitation, simple object access protocol (SOAP), web services description language (WSDL), universal description discovery and integration (UDDI), web services security (WS-Security), web services reliable exchange (WS-ReliableExchange), etc. In one embodiment, the web service 205 is configured to automatically generate an FAQ list for display on a web site. Alternatively, the web service 205 may be configured to update an existing FAQ list on a web site.

In an embodiment, the web service 205 comprises a matching component 206, a updating component 208, and a selecting component 210. Each component is a program, routine, application, computer script, or other machine-executable code capable of performing the actions discussed herein. It will be understood by those skilled in the art that any number of programming languages may be used to configure the matching component 206, the updating component 208, and the selecting component 210. Examples of such languages include, without limitation, C, C++, C#, Java, and the like.

The matching component 206 receives the user input and is configured to locate a question and answer pair corresponding with the user input. In an embodiment, the matching component 206 searches an index of a plurality of known question and answer pairs stored in the database 212 to locate a pair that corresponds to the user input. For example, the user may submit the question “why is the sky blue?” or “sky blue,” either of which would be passed on to the matching component 206. In another embodiment, the matching component 206 has access to an index of values associated with the question and answer pairs stored in the database 212. Such values may include, without limitation, meta tags, keywords, metadata, dates, times, geographic locations, internet protocol (IP) addresses, user rankings, aggregate user rankings, frequency rankings, etc. In one embodiment, the parameters of the user input (e.g., keywords, internet protocol address, date, time, meta tags, etc.) are compared with the values of the question and answer pairs stored in the database 212 to find a matching question and answer pair. It will be understood by those skilled in the art that numerous methods of searching for and locating question and answer pairs may be employed.

A frequency ranking may be used to indicate the number of times the question and answer pair have been requested. A frequency ranking refers to a value that is automatically updated every time a question and answer pair is accessed or located. For example, if a user submits an indication to search for “training a dog to sit,” the question and answer pair “Q: How to train my dog to sit? A: Say ‘sit’ and reward the dog when it sits” may be returned. Upon location of the above question and answer pair, a frequency rating indicating 100 people asked the same question may be incremented to 101. The frequency ranking need not be limited to numerical recordings. Instead, well-known methods of designation data, such as keywords (e.g., highly requested), hexadecimal values (e.g., AAAA FFFF), may be used to indicate the frequency ranking. Other methods of recording the number of time the question and answer pair was accessed may also be used and are generally well known to those skilled in the art.

In one embodiment, exact matching of the user input to a stored question and answer pair is not required. While the matching component 206 can be configured to match the user input for exactly matching questions or keywords in the index, such matching may yield few results. Therefore, the matching component 206 can be configured to match alternative forms of keywords or values. Alternative forms may include any logical variation of a given keyword or value. For example, “money back” could be considered an alternative, and thus synonymous, with “refund.” Or an answer from an IP address in Baltimore, Md. can be an alternative for an answer from Washington, D.C. Using alternative forms may enable the matching component 206 to more accurately locate matching question and answer pairs.

The matching component 206 is configured to communicate with the updating component 208. Once the matching component 206 locates a question and answer pair that matches the user input, the updating component 208 manipulates a corresponding value in the database 212 associated with the question and answer pair. Manipulation may occur by either incrementing, decrementing, modifying, or otherwise changing a value. In one embodiment, the updating component 208 increments a counter to reflect the number of times users are requesting the question and answer pair. In another embodiment, a keyword, such as “frequently asked” is assigned to a value of a question and answer pair. One skilled in the art will understand that various other methods of manipulation are also possible. Constant manipulation of the values in the database 212 corresponding to the matches of user inputs ensures that question and answer pairs do not go stale. In addition, constantly modifying values delineating the frequency or number of times that question and answer pairs are requested enables one to quickly determine which question and answer pairs are most frequently sought.

The updated values associated with the question and answer pairs stored in the database 212 may be used to generate and update FAQ lists on a web site. The selecting component 210 is configured to determine which question and answer pairs in the database 212 to display in an FAQ list on a particular web site. In one embodiment, the selecting component 210 is configured to receive parameters specified by a webmaster, web-site manager, or other user with authority to modify a web site, (hereinafter referred to as the FAQ host) for eliminating question and answer pairs from the particular web site. The FAQ host may submit parameters to the selecting component 210 via the host-computing device 214. These parameters may include a specific user ranking, geographic location, time, date, keyword, frequency rank, meta tag, number of FAQs to display, or similar criteria. In an embodiment, all parameters are stored in the database 212 along with associative data indicating the particular web site's virtual location. In an alternative embodiment, all parameters are stored on the rendering server 216 and are sent to the selecting component upon request. It will be understood by those skilled in the art that numerous methods are well known for submitting, storing, and accessing the FAQ host's parameters.

When multiple question and answer pairs relate to the same topic, it may be desirous to specify the most requested or accessed pair. This may be done any number of ways. For examples, if four question and answer pairs relate to how to treat a stain in a particular fabric, the frequency ranking for each question and answer pair could be periodically checked to identify the most frequently requested pair. To indicate the most frequently requested pair, a value associated with the question and answer pair may be manipulated—such as by tagging the question and answer pair with a keyword or assigning a particular alphanumeric value. In addition, the user ranking and aggregate user ranking may be relied on to specify the most frequently accessed question and answer pair. It will be evident to those of skill in the art that numerous other methods exist for determining which the most frequently accessed question and answer pair and indicating such by manipulating values associated therewith.

The selecting component 210 utilizes the parameters of the FAQ host to determine which question and answer pairs in the database 212 to add to the FAQ list of the particular web site. This determination is made based on the values stored for the plurality of question and answer pairs in the database 212. In one embodiment, the selecting component 210 creates the FAQ list by searching for values in the database 212 corresponding to parameters specified by the FAQ host. For instance, if an FAQ host wished to create a list of the four most frequently asked questions about fixing problems with a particular computer monitor, the FAQ host could designate parameters about “fixing problems” with the particular monitor. Subsequently, the selecting component 210 could mine the question and answer pairs in the database 212 to locate the four most frequently requested question and answer pairs dealing with fixing the particular monitor. These four question and answer pairs could then be sent to an FAQ-generating component 218 (discussed below) and listed on the particular web site.

Embodiments of the present invention are not limited, however, to creating the FAQ list. Rather, some embodiments provide the capability to update existing FAQ lists. In one embodiment, the selecting component 210 and the updating component 208 are configured to communicate with one another. Either component may be configured to monitor the plurality of values associated the question and answer pairs stored in the database 212. Changes in any user rankings, frequency rankings, or other values may be monitored to determine whether such changes necessitate updating the FAQ list. For example, suppose a first question and answer pair on the FAQ list is designated as the most frequently accessed, and later it is determined that a second question and answer pair not listed on the FAQ list is accessed more frequently. The selecting component 210 can then substitute the second pair on the FAQ list for the first pair. In another example, the selecting component 210 may automatically replace a question and answer pair on the FAQ list with a more recent question and answer pair. In an embodiment, question and answer pairs on the FAQ list are updated or replaced by a feed reader that reads a rich site summary (RSS) feed. Embodiments are not limited, however, to RSS feeds, as one skilled in the art will understand that FAQ list updating can be done in a number of ways.

To monitor for changes in question and answer pairs that are within an FAQ list, the selecting component 210 may communicate with the updating component 208 to be alerted to any value changes in the question and answer pairs. In other words, the selecting component 210 may be configured to monitor the values updated by the updating component 208. Or, alternatively, the updating component 208 can be configured to alert the selecting component 210 of any manipulations to values of the FAQ list's question and answer pairs.

The selecting component 210 may be configured to periodically update question and answer pairs in the FAQ list. In one embodiment, the selecting component 210 is configured to determine—during regular time intervals—whether the question and pairs on the FAQ list should be replaced. Such a determination can be made by comparing the values of the question and answer pairs on the FAQ list with the values of question and answer pairs not on the FAQ list. For example, a question and answer pair may added to the FAQ list because it had the highest aggregate user ranking. Yet, if a question and answer pair that is not on the FAQ list has a higher aggregate user ranking thirty minutes later, the selecting component 210 can be configured to replace the first pair with the second pair. Furthermore, the time interval may be specified in a number of ways. For instance, a user may enter the time interval into a user interface on the host-computing device 210. Alternatively, a webmaster may specify the time interval on any type of computing device (not pictured in FIG. 2 for clarity) communicating with the server 204. One of skill in the art will understand that numerous methods can be implemented to specify the time interval.

The rendering server 216 is a server configured to store a web site—along with the relevant information associated with the web site—as a collection of static and dynamic web pages. Rendering servers are generally well known to those skilled in the art and need not be discussed at length herein. As FIG. 2 illustrates, the FAQ-generating component 218 may also be executed on the rendering server 216. The FAQ-generating component is configured to receive question and answer pairs from the selecting component 210 and either create an FAQ list 220 or update an existing FAQ list 220. The FAQ list 220 is the list of question and answer pairs as they would look on the particular web site. In other words, the FAQ list 220 contains the question and answer pairs configured with the web site's styles, fonts, and other display characteristics. While FIG. 2 depicts the FAQ-generating component on the rendering server 216, it may alternatively be executed on the server 204.

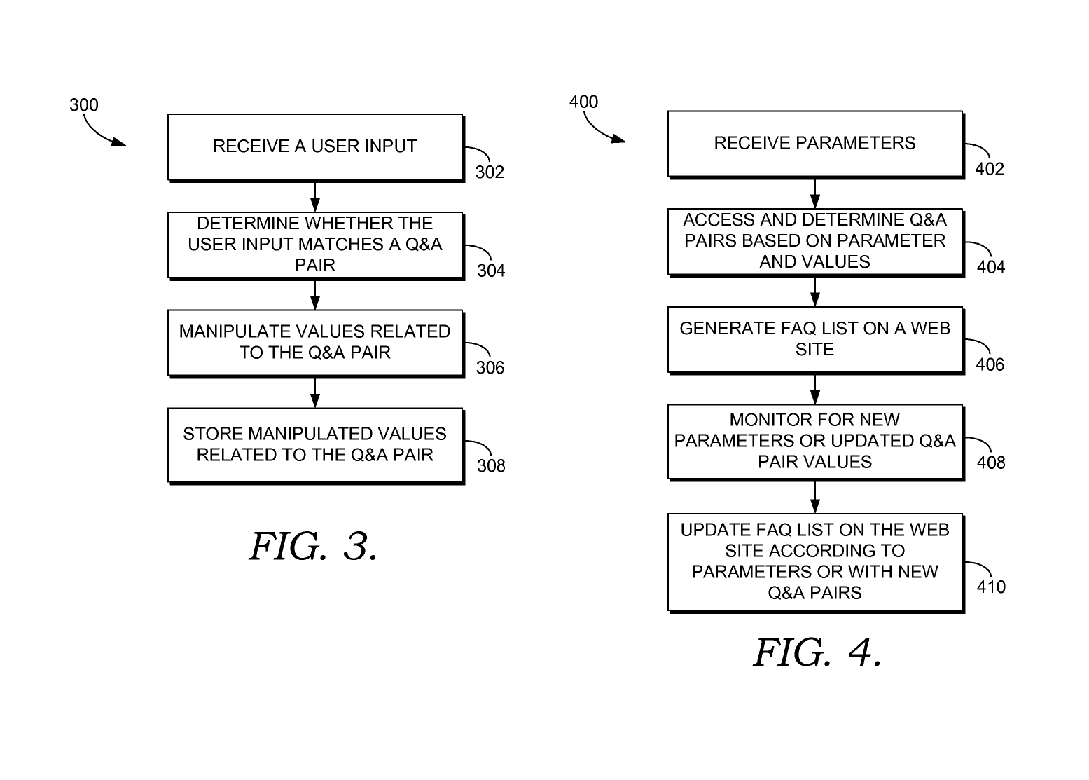

Turning now to FIG. 3, a flowchart is presented illustrating a process 300 for manipulating values associated with question and answer pairs based on a user's input, according to various embodiments of the present invention. Initially, a user input is received, as indicated at 302. The user may enter a question or keyword to be answered or select a question or keyword from a list of questions or keywords. In one embodiment, the user input is a selection of an alternative question or keyword.

It is then determined whether the user input matches a question and answer (referenced in FIGS. 3 and 4 as Q&A) pair, as indicated at block 304. This may be done by a matching component, such as the matching component 206 of FIG. 2. In an embodiment, the matching component searches an index of values and corresponding question and answer pairs for a keyword or value that matches the user input. In another embodiment, alternative forms of keywords or values may be used to match the user input. If a question and answer pair is located, values relating to the question and answer pair are manipulated to reflect that the question and answer pair were requested, as indicated at block 306. Manipulation may occur by either incrementing, decrementing, modifying, or otherwise changing a value. In one embodiment, an updating component (such as the updating component 208 of FIG. 2) increments a counter to reflect the number of times users are requesting or accessing the question and answer pair. In another embodiment, a keyword, such as “frequently asked” is assigned to a value of a question and answer pair. One skilled in the art will understand that various other methods of manipulation are also possible. The manipulated values are subsequently stored, as indicated at block 308. The values may be stored in any data-storage medium, such as the database 212 of FIG. 2, by an updating component, such as the updating component 208 of FIG. 2.

FIG. 4 illustrates a process for automatically generating and updating an FAQ list, according to various embodiments of the present invention. Initially, parameters are received, as indicated at block 402. In an embodiment, the parameters are submitted by the FAQ host and may include a specific user ranking, geographic location, time, date, keyword, frequency ranking, meta tag, number of FAQs to display, or similar criteria. In another embodiment, a selecting component (such as the selecting component 210 of FIG. 2) receives the parameters.

Subsequently, a plurality of stored question and answer pairs are accessed, and it is determined whether any question and answer pairs exist that contain values corresponding to the parameters, as indicated at 404. In an embodiment, the selecting component searches for relevant question and answer pairs in the data-storage medium. Relevant question and answer pairs, if found, may be sent to an FAQ-generating component (such as the FAQ-generating component 218 discussed above) to generate an FAQ list for display on the FAQ host's web site. This is indicated at block 406.

Once an FAQ list is generated, embodiments may also be directed to monitoring for new parameters or updated question and answer pair values, as indicated at block 408. In one embodiment, the selecting component monitors the updating component for value changes to question and answer pairs on an FAQ list. Alternatively, the updating component is configured to alert the selecting component of any such value changes.

When values change, the FAQ list may be updated according to specified parameters or with new question and answer pairs, as indicated at block 410. In an embodiment, this updating is completed by the selecting component.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

1. One or more computer-readable media having computer-executable instructions embodied thereon for performing a method to automatically generate a frequently asked question (FAQ) list, the method comprising:
receiving a user input requesting information;
determining one or more question and answer pairs related to the user input from a plurality of stored question and answer pairs;
manipulating one or more values related to the one or more question and answer pairs based on the user input; and
determining at least one question and answer pair for the FAQ list based at least in part on a plurality of values associated with the plurality of stored question and answer pairs.

2. The one or more computer-readable media of claim 1, wherein the user input comprises one of a question or a keyword search submitted by a user.

3. The one or more computer-readable media of claim 1, wherein the user input comprises receiving data indicative of a user selecting an alternative question from a list of one or more alternative questions.

4. The one or more computer-readable media of claim 1, wherein determining one or more question and answer pairs related to the user input further comprises searching an index of keywords.

5. The one or more computer-readable media of claim 1, wherein manipulating one or more values related to the one or more question and answer pairs further comprises increasing a frequency ranking, wherein the frequency ranking indicates the number of times the question and answer pair has been accessed.

6. The one or more computer-readable media of claim 1, wherein the one or more values related to the one or more question and answer pairs comprise one of an alphanumeric value, hypertext markup language (HTML) tag, binary value, hexadecimal value.

7. The one or more computer-readable media of claim 1, comprising automatically updating the FAQ list with the one or more question and answer pairs.

8. The one or more computer-readable media of claim 1, comprising presenting the FAQ list as a portion of a web site.

9. The one or more computer-readable media of claim 1, wherein the one or more values related to the one or more question and answer pairs comprise a user ranking, wherein the user ranking is indicative of one or more users' indication as to the sufficiency of an answer related to a question in the question and answer pair.

10. The one or more computer-readable media of claim 1, wherein the user input requesting information comprises one of a selection of a presented question and answer pair or a keyword-search result.

11. The one or more computer-readable media of claim 1, wherein the one or more values related to the one or more question and answer pairs include one or more user rankings that are indicative of one or more users' belief that an question and answer pair is informative.

12. The one or more computer-readable media of claim 1, wherein determining one or more question and answer pairs related to the user input comprises:
searching an index of the plurality of values associated with the plurality of question and answer pairs; and
locating the one or more question and answer pairs from the index.

13. A computer-implemented method for automatically generating a frequently asked question (FAQ) list, the method comprising:
receiving one or more parameters for selecting one or more question and answer pairs for the FAQ list;
accessing a plurality of question and answer pairs and a plurality of values related to the question and answer pair; and
based on the plurality of values and the one or more parameters, determining at least one question and answer pair for the FAQ list.

14. The method of claim 13, comprising automatically updating the FAQ list with the at least one question and answer pair.

15. The method of claim 13, comprising:
determining whether to update the FAQ list with additional question and answer pairs based on the plurality of values and the one or more parameters; and
updating the FAQ list with the additional question and answer pairs.

16. The method of claim 13, wherein the plurality of values includes one of a hypertext markup language (HTML) tag, metadata, keyword, date, time, geographic location, or user rating.

17. The method of claim 13, wherein the one or more parameters include one of a hypertext markup language (HTML) tag, metadata, keyword, date, time, geographic location, or user rating.

18. The method of claim 13, wherein the one or more parameters are supplied by a user with authority to modify a web page.

19. A server having one or more computer-readable media with components embodied thereon for automatically providing one or more question and answer pairs for a frequently asked question (FAQ) list, wherein the server has access to a plurality of question and answer pairs along with a plurality of values related to the plurality of question and answer pairs, the components comprising:
a matching component configured to determine one or more of the plurality of question and answer pairs corresponding to the user input; and
an updating component configured to manipulated one or more values associated with the plurality of question and answer pairs based at least in part on information from the matching component; and
a selecting component configured to select one or more question and answer pairs from the plurality of question and answer pairs for the FAQ list based on the plurality of values, wherein the plurality of values are manipulated by the updating component.

20. The server of claim 19, further comprising a frequently asked question (FAQ) generating component configured to automatically modify an FAQ list with at least one of the one or more question and answer pairs based on at least one relevant value.
